(19) United States
(12) Patent Application Publication
(10) Pub. No.: US 2007/0077173 A1
(43) Pub. Date: Apr. 5, 2007

(54) Compact analyzer for dry biochemical analysis of blood samples

(76) Inventor: Francois Melet, Auvernier (CH)

Correspondence Address: BROWDY AND NEIMARK, P.L.L.C.;624 NINTH STREET, NW, SUITE 300, WASHINGTON, DC, 20001-5303, US

(21) Appl. No.: 11/541,555

(22) Filed: Oct. 3, 2006

(30) Foreign Application Priority Data
Oct. 3, 2005 (FR) 0510081

(51) Int. Cl. G01N 35/00

(52) U.S. Cl. 422/64

(57) ABSTRACT

A compact analyzer for dry biochemical analysis of blood samples, integrating onto a common chassis (11):
a measuring chamber (20) adapted to receive a disposable rotor (13) including microtanks (13A, 13B) containing dry reagents,
a digital dilution module (21) of fixed or variable ratio defined as a function of the species of the sample to be analyzed,
a sample centrifuging module (12) adapted, inside the measuring chamber, to centrifuge the rotor and position it angularly,
an optical module adapted to apply beams of light to microtanks of the rotor, this optical module including a flash-lamp type light source (14) and a reference light sensor (16),
an electronic processing and control system (23, 24, 25) including an external memory reader (26) adapted to read a portable external memory (27) containing at least information characteristic of at least the disposable rotor in use.

The invention concerns a compact dry biochemical analyzer for the analysis of blood samples, particularly samples of plasma.

### STATE OF THE ART

Two principles are competing at present on the market for these analyzers:
the test-by-test principle used particularly in the apparatus distributed by VETTEST under the reference IDEXX, by J&J under the reference VITROS DT60, by ARKRAY under the reference SPOTCHEM or by FUJI under the reference FUJI3000, and
the complete check-up principle (typically 4 to 16 parameters, according to the circumstances) effected by rotor analyzers such as those distributed by ABAXIS under the reference VETSCAN & PICCOLO or by HEMAGEN under the reference ANALYST II.

In practice some of the analyzers utilizing the test-by-test principle may be used to effect complete check-ups when there is provision for it to be possible to select a group of tests constituting a meaningful check-up.

The analyzers using the “test-by-test” principle have advantages:

1) the possibility of selecting an individual test (test-by-test procedure) leads to a reduced unit cost for the diagnosis of a patient,

2) it is possible to compose ‘à la carte’ check-ups, by an appropriate selection of the individual tests requested to constitute the required specific check-up.

On the other hand, these analyzers have drawbacks:

3) the equipment is complex to manufacture, to enable the various possible options,

4) the management of the test boxes is difficult (surveillance, test box by test box, situations of expiry or of resupply),

5) the unitary test boxes must be manipulated individually to enable the composition of the check-ups,

6) the possible check-ups are limited in terms of the number of individual tests (because the individual test unit element is of bulky size),

7) individual calibrations are necessary in most cases,

8) the reliability of the veterinary results is only relative because of their lack of adaptability to the plasma concentrations of the parameters of the animal world (excluding the human domain),

9) these analyzers use a flash lamp with no reference, or a tungsten lamp illumination system, not allowing extremely precise measurements of certain parameters such as the T4 hormone (i.e. certain immunological tests) and electrolytes (Na+, K+, Cl−).

Equipments such as the SPOTCHEM EZ analyzer from the company ARKRAY offer the immediate possibility of choosing the test-by-test mode or the check-up mode, but the check-up mode is limited to nine parameters, and this number of parameters (nine tests) in a check-up is very often insufficient to allow a meaningful diagnosis.

Rotor analyzers for the “complete check-up” type have diverse advantages compared to analyzers of the “test-by-test” type:

1) the principle of the apparatus is simpler,

2) the necessary manipulations are reduced,

3) the rotors allow easy management (small overall volume and easy management of expiry dates),

4) the check-ups possible are more complete (up to 16 parameters, in practice),

5) the check-ups are “already ready”, i.e. predefined, so that there is no check-up composition work involved.

On the other hand, these rotor analyzers have the following drawbacks:

6) the necessary calibrations are costly (in the case of automatic calibrations carried out with onboard calibration standards, in analyzers such as the VETSCAN & PICCOLO analyzer from ABAXIS) or irksome (in the case of manual calibrations, in analyzers such as the ANALYST II analyzer from HEMAGEN),

7) the obligatory dilution of the plasmas is effected by a costly automatic fixed ratio dilution unit on board the rotor (in the case of the ABAXIS analyzer) or using an external manual diluter having the drawback of taking up a large volume on the mattress (which may be unacceptable for so-called compact apparatus where the customer base is essentially that of doctors' surgeries with restricted working space),

8) the reliability of the veterinary results is also only relative because of their lack of adaptability to the plasma concentrations of the parameters of the animal world,

9) the flash lamp has no reference light sensor, or is a tungsten lamp illumination system, not allowing extremely precise measurement of certain parameters such as the T4 hormone and electrolytes (Na+, K+, Cl−),

10) since there is no management of the individual tests, establishing an overall check-up is costly if the client requires only a few tests rather than all the tests that are offered in a check-up.

### TECHNICAL PROBLEM AND SOLUTION PROVIDED BY THE INVENTION

The invention has for its subject matter an analyzer having the advantages of rotor analyzers without their drawbacks.

To this end the invention proposes a compact analyzer for dry biochemical analysis of blood samples, integrating onto a common chassis:

a measuring chamber adapted to receive a disposable rotor including at least one diluted sample receiving central chamber and, around that central chamber, a plurality of microtanks containing dry reagents and adapted to receive fluid from that central chamber during centrifuging of this rotor,

a digital dilution module of fixed or variable ratio defined as a function of the species of the sample to be analyzed and adapted to dispose a diluted sample into a central chamber of this rotor from a blood sample from a given species,

a sample centrifuging module adapted, inside the measuring chamber, to centrifuge the rotor and position it angularly at a plurality of angular positions,

an optical module adapted to apply beams of light to the interior of the measuring chamber, in areas that may be occupied by microtanks of the rotor, in at least some of said angular positions of the rotor, this optical module including a flash-lamp type light source and a reference light sensor,

an electronic processing and control system for controlling the dilution module, the optical module and the centrifuging module, to acquire measurements from the beams intercepted by said areas of the measuring chamber, to process these measurements and to deduce results therefrom, said processing system including an external memory reader adapted to read a portable external memory containing at least information characteristic of at least the disposable rotor in use.

According to advantageous features of an analyzer of the invention, which may where applicable be combined:

the external memory contains information concerning the calibration of the rotor and the expiry date of the dry reagents contained in this rotor,

the external memory further contains information, updated by the electronic processing system, on the use of the rotor in use; this enables tracking of the use of a given rotor,

the external memory contains information, updated by the electronic processing system, on the numbers of tests that have been effected with the respective dry reagents, which allows, where applicable, tracking the tests that remain possible and those already entirely consumed; this also allows billing as a function of the use made of the rotors,

the external memory contains information, updated by the electronic processing system, on the number of tests that can still be effected with the dry reagents; it is in fact possible to manage the replacement of the rotors,

alternatively, the external memory contains information, updated by the electronic processing system, on tests effected and requested and on tests effected but not requested; this avoids having to start over the drawing of a sample from a human or animal patient or to begin tests again; in fact, in this way a certain batch of tests (or even all of the possible tests) may be carried out in all cases, but the results to be accessible only as a function of the tests asked for (which are billed), so that a subsequent request for tests is processed simply by making available the results of the tests covered by the new request, subject to additional billing),

the external memory contains information characteristic of a batch of disposable rotors; in fact, the rotors are generally manufactured and purchased in batches,

the external memory is a microcircuit card, which is a type of memory that is easy to manufacture and to manage; alternatively, the external memory is a Compact Flash type card or a USB key, which also corresponds to memories the performance whereof is well known,

the digital diluter includes a piston actuated by a motor, this piston and this motor being mounted on the chassis, and a manipulation handle provided with a sampling and injection nozzle, which enables dilution of the sample to be analyzed to a ratio defined as a function of the species of the sample to be analyzed,

the centrifuging module includes an eccentric stepper motor, pinions fixed to the shaft of this motor and to a drive shaft carrying the rotor in use and a belt cooperating with these pinions, which allows flexibility in terms of the angular step through which the rotor turns on each step of the motor,

the reference light sensor is mounted, inside the optical module, on a beam splitter,

the optical module further includes a monochromator, such as a filter wheel,

the electronic control system includes input means for entering the species to which the blood sample belongs, and activates the dilution means as a function of that input,

the electronic control system includes input means for entering individual tests to be effected on the rotor in use,

it includes a module for regulating by pulsed air and a Peltier system the temperature of the measuring chamber to a precise and stable temperature.

The invention advantageously utilizes rotors of the type used by the analyzers from HEMAGEN (see above).

An analyzer according to the invention addresses the technical problem defined above. In particular, with reference to the drawbacks mentioned hereinabove in respect of rotor analyzers, it may be noted that:
Drawback 6: the costly or irksome calibrations are avoided thanks to an external memory system, of the microchip card type, in which there have been stored beforehand the factory calibration values relating to the rotors ready for use; this external memory system may be shipped with the pack of rotors ready for use and is inserted upon use of the first rotor, which enables the analyzer to store all of the calibrations relating to the rotors concerned; this leads to a significant advantage in terms of cost, time and reliability for these calibrations,
Drawback 7 (second part): a compact diluter is integrated into the chassis of the apparatus, with the result that it takes up no additional space on the mattress,
Drawbacks 7 (first part) and 8: the integrated diluter is digital and enables accurate ‘à la carte’ dilution as a function of the animal species to be analyzed (including the human species); this selection of the dilution is effected automatically at the time of selection, on the analyzer, of the biological species concerned and enables adaptation of the plasma concentrations to the ranges of measurement linearities on the apparatus,
Drawback 9: the use of a reference light sensor significantly improves the accuracy of the measurements of difficult parameters such as the T4 hormone or electrolytes,
Drawback 10: the use of the external memory system (typically of the microchip card type) enables management of the rotors on a test-by-test basis through internal downcounting.

### DESCRIPTION OF THE INVENTION

Objects, characteristics and advantages of the invention emerge from the following description, given by way of illustrative and nonlimiting example, with reference to the appended drawings, in which:

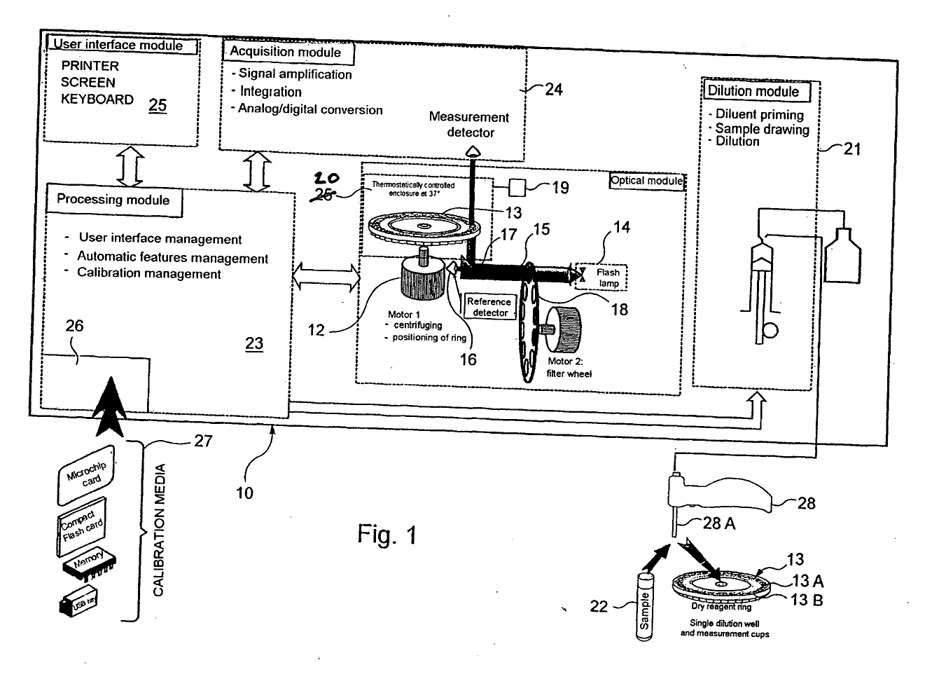

FIG. 1 is a structural diagram of an analyzer conforming to the invention,

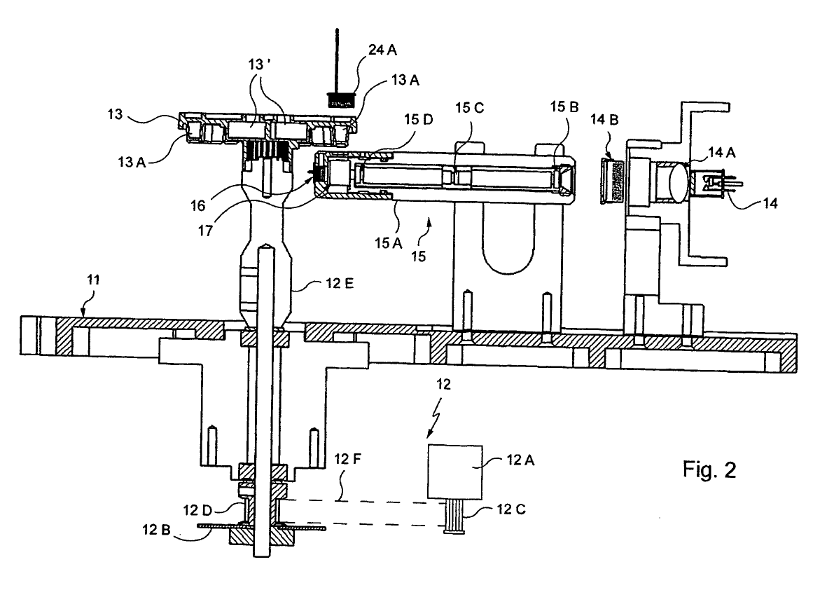

FIG. 2 is a detailed schematic of the optical unit of that analyzer, and

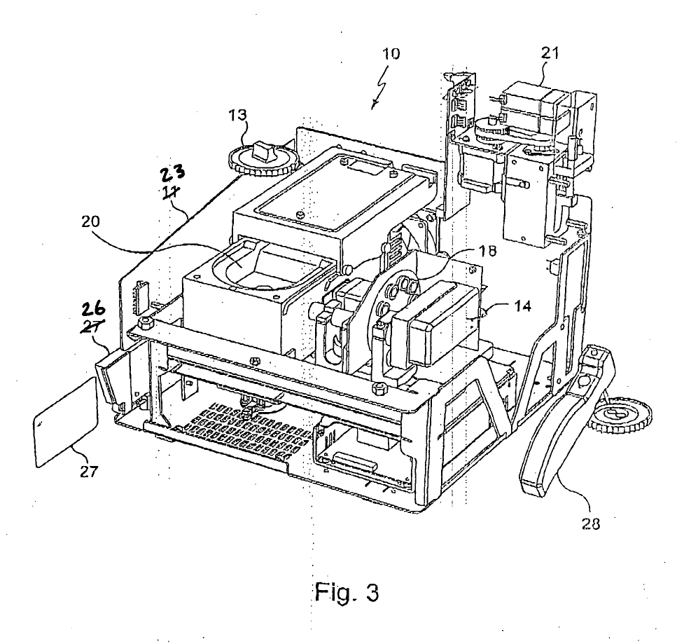

FIG. 3 is an exploded perspective view of that analyzer.

The figures represent a compact dry biochemical analyzer (rotor type analyzer) 10 according to the invention that integrates into a common chassis 11:
a sample centrifuging center 12, adapted to receive rotors 13 including measurement microtanks 13A, 13B, etc., respectively containing a dry reactional preparation (accordingly, in a manner that is known in the art, particularly in analyzers from ABAXIS or HEMAGEN, a rotor is the combination of a cellular plastic structure and dry reagents in said cells), and to ensure homogeneous distribution to and filling of these microtanks,
an optical module adapted to effect a spectrophotometric measurement, including (i) a light source 14 in the form of a flash lamp, (ii) an optical channel 15 adapted to transport the light beam emitted by the source and provided with a reference light sensor 16 mounted on a beam splitter 17, and (iii) a filter wheel or a monochromator 18 adapted to select one wavelength,
a system 19 for accurate regulation of the temperature of the measurement and centrifuging chamber 20 containing the rotor to a value around 37° C.,
a digital dilution module, or diluter, 21 adapted to effect a single or double dilution, for the preparation of the sample (by manual or automatic dilution of a sample 22 of plasma to be analyzed),
an electronic control system including (i) a processing module 23 controlling all mechanical functions (dilution, centrifuging, thermostatic control, flash lamp), (ii) an acquisition module 24 providing the integrated measurement of the monochromatic flash light transmitted to each of the measuring microtanks and the calculation of the measured and corrected values (NB: this measurement function may instead be provided by the processing module), (iii) a capture and display module 25 for the presentation of the results (selection, display, printout) and the whole of the user interface,
a reader 26, in practice connected to the processing module to read the content of a portable information storage unit 27 storing information relating to the rotors and to their use (FIG. 1 shows, under the reference 27, various possible storage units (microchip card, Compact Flash card, memory, USB key, etc.)).

According to one characteristic of the invention, a rotor analyzer thus includes an integrated diluter 21 using ‘digital’ metering linked to the species from which the sample to be analyzed was drawn. This diluter, here of the single-piston type, allows preparation of the (plasma) sample in one or two successive manual or automatic dilutions, and therefore, according to the invention, allows this dilution to be adapted to the particular concentrations of the plasma parameters of the species to be metered (i.e. to be analyzed). This so-called ‘digital’ integrated diluter has the particular feature of being able to sample a programmed and/or programmable quantity of plasma and then to dilute that plasma in a programmed and/or programmable quantity of diluent). The programming values of the dilution (sampling of the plasma and addition of diluent) being linked to the animal species (including the human species, and therefore man) to be analyzed, these programming values being introduced into the analyzer in the manner indicated hereinafter.

According to a further feature of the invention, the analyzer is capable of managing the data linked to each type of reagent (rotor) by way of an external memory medium (microchip card, SD card, etc. type) allowing the storage of information such as:

a) the type of parameters/analyses (profile) defining the reagents contained in the cells of the rotor, the rotor model, and its batch number and reference,

b) the expiry date of the reagents and therefore of the rotor, from the manufacturing date of the rotor, and even, and advantageously, including its thermal history of transport and storage,

c) the calibration and specific correction values of each parameter linked to each batch of rotors,

d) the number of parameters/tests that can be performed, or at least rendered accessible on demand, with all of the rotors purchased by the customer (according to a principle analogous to that of the units of a telephone card, for example). In fact, this external memory medium also allows the ‘per test’ use and billing of the rotors provided in so-called ‘selective’ mode (test-by-test selection over the whole of the so-called “profile” panel of the rotor) thereby providing simpler billing and/or billing adapted as a function of the specific check-ups created by the operator using the apparatus.

Various comments may be made on the component parts of the analyzer represented.

1) Rotors: The morphology of the rotors used in an analyzer conforming to the invention is of a type known for many years. It is a circular plastic structure 13 carrying, at its center, one or more chambers 13′ for receiving an automatically or manually diluted sample of blood plasma, and at its periphery a set of microtanks 13A containing dry biochemical reagents defining the ‘parameters’. Some of these rotors can accept up to 24 (or more) measuring microtanks. Rotating this rotor, through the centrifugal effect, distributes (by the centrifugal force) the diluted sample placed in a central position towards the periphery (towards the microtanks) in a homogeneous and simultaneous manner. The method then consists in reading the specific colorimetric chemical reactions of each parameter/test (in any event each requested parameter/test), in each of the microtanks that is allocated to it, by a spectrophotometric method using the optical module.

2) Optical system: The optical system (see FIG. 2) includes, in a manner known in the art, (i) a flash type light source 14, (ii) an optical channel 15 formed of a support tube 15A and composed of optical lenses conveying the light ray to the sample to be measured, and (iii) a specific wavelength selection system (filter wheel or monochromator) to be used for the measurement of the chemical reaction (not shown in FIG. 2). In the example considered here, the light source is of the xenon type and is followed by an aspherical condenser 14A and an interferential filter 14B; the optical channel here includes an entry pupil 15B, a field lens 15C, and an exit pupil 15D. This optical system is distinguished here by a technique that is innovative on this type of super-compact analyzer, consisting in the incorporation of a reference light sensor 16 on the optical axis behind a beam splitter 17 allowing monitoring of (i) individual flashes (which are not always homogeneous in all circumstances) and (ii) the residual overall power of the flash, which below a certain power may no longer be usable. Observe that in this FIG. 2 the beam then passes through a microtank 13A and reaches a measuring photodiode 24A forming part of the acquisition module.

3) Centrifuging system: The centrifuging system 12 is based on a mechanical assembly including (i) a stepper motor shown diagrammatically under the reference 12A, (ii) a centrifuging and drive shaft 12E supporting a rotor and referenced optically (see the wheel 12B in FIG. 2), (iii) notched pinions 12C and 12D mounted on the drive shaft and on the centrifuging shaft 12E, and (iv) a notched belt 12F connecting these two pinions; this centrifuging system therefore allows (a) centrifuging of the sample by rotation at high speed, then (b) accurate positioning (to the accuracy of the motor step) of each of the measuring microtanks containing the reaction sample to be measured in front of the optical beam. A unique feature of this assembly is that (i) for rotors including 24 microtanks the positioning of the microtanks on the axis of the optical beam is obtained thanks to the accuracy of the ‘motor step’ that can be effected here other than by motors with 24 or 48 steps per revolution that no longer exist and (ii) for rotors having more or fewer measuring microtanks, a simple judicious choice of the notched wheels (number of teeth on both of the pinions) suffices to satisfy the adaptation of any type of rotor to be analyzed to this type of apparatus.

4) Onboard (integrated) dilution system 21: The digital single-piston onboard diluter allows manual or automatic dilution in one or more steps of the sample of blood plasma. It is composed of (i) a stepper motor connected to (ii) a single piston with two functions, that of sampling the plasma and that of diluting it, by (iii) a notched pinion and belt assembly activated by (iv) an external manipulator handle 28 having a sampling nozzle 28A. According to one entirely advantageous particular feature of the invention:

This single-piston diluter is integrated into the same chassis as all of the other functions of the apparatus, and this in the context of a particularly compact biochemical analysis apparatus. In fact, at present, most biochemical analyzers of compact size necessitating a diluter include such diluters externally (HEMAGEN) or a diluter integrated into the rotor (ABAXIS); otherwise, it is a question of a biochemical analyzer of much larger size that does not fall within the “compact” concept of the invention (in fact these large size analyzers generally have a plurality of diluters architectured around a plurality of pistons specific to sampling and dilution).

The dilutions are adaptable as a function of the animal species (including the human species) to be analyzed. This adaptability is achieved by the digital control of the single-piston diluter from preprogrammed values of dilution of the plasma of the species selected. This adaptability of dilution offers the enormous advantage of adjusting the usual concentration of the plasma parameters of the species to the ranges of optical measurements of the parameters.

5) Measuring chamber system: The measuring chamber, conventionally accessible via a top lid, receives the prepared rotor (diluted and distributed plasma). According to an advantageous particular feature of the invention, there are effected in this chamber (i) the thermostatic control to a temperature of 37° of the chamber plus rotor assembly, (ii) the centrifuging of the diluted sample(s) and, at the end, the optical measurement of the microtanks that have received the diluted sample(s). The thermostatic control of the temperature of the sample is advantageously effected by means of pulsed hot air and regulated by an electronic sensor controlling a filament type heating unit and a Peltier effect cooling system. All this guarantees an internal temperature of the chamber accurately stabilized to around 37°, and this throughout the process of centrifuging the diluted plasma and then of measuring the parameters.

6) Rotor (reagent) management system using external memory medium: An external memory medium of the ‘microchip card’ (or other) type is shipped with each box of reagent (rotors). This memory medium is prepared in the factory and contains information concerning the rotors with which it is associated, this information including (i) the identification (type and batch number) of the rotors, (ii) the validity date (and thus the expiry date) of the rotors, (iii) the data relating to calibration and/or correction of the parameters of the rotors, (iv) ‘à la carte’ management of the price of the test as a function of the results requested and the tests carried out (as indicated hereinafter, there may be more tests carried out than tests requested). On receiving the reagents (rotors), or just before the analysis, the customer (the operator) introduces the memory medium into the analyzer and thus loads into the apparatus the data relating to the rotors received. This data must of course be correlated with the identification of the rotors themselves before anything else and advantageously allows the management of:

a) The expiry date: this date is the ‘use by’ date of the rotors starting from the date of their manufacture.

b) The thermal history of the rotor: this thermal history can be used to correct the ‘use by’ date by bringing the expiry date forward as a function of thermal ‘ups and downs’ suffered by the rotor during its transportation and its storage.

c) The calibration data of each of the parameters of the rotor: the calibration of the rotors rendered necessary by the fluctuation of the constituents of the reagents is carried out in the factory and allows a considerable cost saving over the competition which must have calibrating agents on board the rotors (ABAXIS) or is obliged to calibrate the analyzer for each new batch of rotors (HEMAGEN).

d) The correction data of each of the parameters of the rotor: the correction of the rotors rendered necessary by the fluctuation of the plastic and other components is carried out in the factory. This data improves measurement quality.

e) So-called ‘selective’ profiles: the onboard memory medium contains a number of prepaid parameters that the end user can manage to suit himself in ‘à la carte’ mode, also known as ‘selective’ mode. This advantageous mode of management of use of the rotors enables partial use of the rotor by selecting the required check-ups on a ‘parameter by parameter’ basis. Only the parameters selected (rendered, i.e. rendered accessible to the operator) will be taken into account in the downcounting mode relative to the maximum number of tests allowed on the memory medium (like a telephone card). The enormous advantage of this preferred management mode is (i) unit billing of the parameters on the basis of a reagent oriented for a primarily global or so-called ‘profile’ use, which does not exist in any analyzer in this field, (ii) the immediate obtaining of parameters complementary to the selective check-up effected, since ‘in the end’ all the parameters of the rotor have been processed (i.e. all the tests have been carried out, and then read), and this simply by decrementing the number of prepaid parameters. In fact all the tests may advantageously be executed, optically read and stored in memory, but only the results of the tests that the operator has selected being made available to the operator. It follows from this that it is possible to return afterwards to all of the results for a sample and to have access to results of complementary tests if, for example, the analysis of the tests initially selected justifies it. This storage of test results other than those actually selected at the outset in accordance with a first profile (advantageously, all of the test results possible with a given rotor are stored) offers a possibility of “à la carte” recall, even several days after the execution of this first profile, which avoids having to (i) recall the patient, who may no longer be present in the clinic (or the laboratory), (ii) take a new sample of the blood of the patient (which may be a difficult action in certain critical situations), and (iii) effect a new manipulation and preparation of a new check-up with the consumption of a new rotor (which could lead to a high cost).

### OPERATIONAL CYCLE

1) Blood sampling, centrifuging: A blood sample 22 of an animal species (including the human species) is drawn from a subject on a specific anticoagulant and then centrifuged (not shown).

2) Preparation, dilution: The animal species to be analyzed is selected in the data bank of the analyzer (by action on the interface module 25 or insertion of a memory 27 into the reader 26), and the plasma (upper portion of the centrifuged blood) is presented to the sampling nozzle 28A of the manipulating handle 28 of the diluter 21. The dilutions of the plasma with a view to its preparation in the rotor, to the dilution ratio defined and selected in the internal bank of the analyzer, are thus effected by the operator.

3) Introduction of the rotor: The dilution or dilutions having been carried out, the rotor is introduced, after opening the top lid of the measuring chamber, into the chamber of the analyzer. The data characterizing the rotor is then read off its upper portion by means of a bar code previously inscribed in the factory and is correlated with the identification, calibration, correction and rotor parameter management data supplied by the external memory medium 27.

4) Selection of tests if in selective mode: This selection is optional (in profile mode there is no selection to be done, the rotor will be read completely, microtank after microtank), carried out in practice by means of the interface module 25.

5) Launching of the analysis: The top lid of the measuring chamber being closed, the ‘start measurement’ key is activated (on the interface module 25).

6) Thermostatic control of the rotor: Thanks to the temperature control element 19, the temperature of the chamber and therefore that of the rotor and of the content of its central chambers 13′ are brought to 37° C. during a given time by pulsed air and the temperature is controlled by the Peltier effect.

7) Centrifuging, distribution of the plasma: The diluted plasma at the center of the rotor is distributed into each measuring microtank by centrifuging. This centrifuging is also effected for a precise time at a precise centrifuging speed.

8) Measurement of samples: When the centrifuging has been done, the measuring microtanks are brought one by one in front of a light beam at a specific wavelength linked to each (reagent) parameter contained in the measuring microtank (it suffices to actuate the wheel 18). Different measurements are thus carried out (acquisition module 24), certain parameters being measured at the ‘end point’ (after equilibrium), other parameters being measured ‘kinetically’ (as a function of time).

9) Calibration, correction of the results: At the end of analysis the results of each of the measurements are calibrated and/or corrected (with the aid of the processing module 26) as a function of the data that has been put on board the external memory medium linked to the rotors.

10) Output of the results: As a function of the mode chosen for obtaining the expected results, total profile or selective mode, the results are then rendered, i.e. displayed and/or printed and/or exported via an electronic data processing interface (by the module 25).

From a practical point of view, the sampling and the analysis of the sample may be effected by the assistant or by the carer whereas the treating doctor, or the veterinarian, sometimes busy at this time (doctor dealing with an emergency outside, or veterinarian carrying out surgery during the morning) are involved only later to ‘read’ and interpret the analysis. This is of value primarily for routine check-ups where the patient does not need an immediate consultation.

The following example allows appreciation of the flexibility of use that is offered by an analyzer conforming to the invention, in the case where the memory medium (microchip card, or any other electronic memory medium) stores more test results than were initially requested.

A blood sample from the (human or animal) patient is taken in the morning (“prelunch”) for a blood analysis to verify the following parameters: (1) glucose, (2) urea. This “2-parameter” check-up is certainly one of the smallest check-ups that can be effected in routine testing (normal reaction of a practitioner who does not wish to spend too much on a routine test). The doctor (or the veterinarian, as appropriate) may discover a strong abnormality in one of the parameters to the point where he wishes to consult a few complementary parameters such as (3) cholesterol, (4) triglycerides. There is no need to recall the patient for a new sample (especially if the sample is no longer available) or even to manipulate again another extract from the sample remaining available with a view to new analyses by means of a new rotor. It suffices for this doctor/veterinarian to recall onto the screen of the analyzer the check-up already effected and stored for the patient in question and to open, in the complete list of tests effected and available that can be displayed, only the cholesterol test (3) and the triglyceride test (4). These latter two tests will then be displayed, printed out and downcounted from the microchip card. This kind of manipulation is also beneficial in situations where the patient's medical records are available in the doctor's surgery so monitoring of the patient can be completed at any time by a wider ‘display’ of the condition of the patient at the time ‘t’, and this retrospectively.

1. Compact analyzer for dry biochemical analysis of blood samples, integrating onto a common chassis (11):
a measuring chamber (20) adapted to receive a disposable rotor (13) including at least one diluted sample receiving central chamber (13′) and, around that central chamber, a plurality of microtanks (13A, 13B) containing dry reagents and adapted to receive fluid from that central chamber during centrifuging of this rotor,
a digital dilution module (21) of fixed or variable ratio defined as a function of the species of the sample to be analyzed and adapted to dispose a diluted sample into a central chamber of this rotor from a blood sample (22) from a given species,
a sample centrifuging module (12) adapted, inside the measuring chamber, to centrifuge the rotor and position it angularly at a plurality of angular positions,
an optical module adapted to apply beams of light to the interior of the measuring chamber, in areas that may be occupied by microtanks of the rotor, in at least some of said angular positions of the rotor, this optical module including a flash-lamp type light source (14) and a reference light sensor (16),
an electronic processing and control system (23, 24, 25) for controlling the dilution module, the optical module and the centrifuging module, to acquire measurements from the beams intercepted by said areas of the measuring chamber, to process these measurements and to deduce results therefrom, said processing system including an external memory reader (26) adapted to read a portable external memory (27) containing at least information characteristic of at least the disposable rotor in use.

2. Analyzer according to claim 1, characterized in that the external memory contains information concerning the calibration of the rotor and the expiry date of the dry reagents contained in this rotor.

3. Analyzer according to claim 1, characterized in that the external memory further contains information, updated by the electronic processing system, on the use of the rotor in use.

4. Analyzer according to claim 3, characterized in that the external memory contains information, updated by the electronic processing system, on the numbers of tests that have been effected with the respective dry reagents.

5. Analyzer according to claim 4, characterized in that the external memory contains information, updated by the electronic processing system, on the number of tests that can still be effected with the dry reagents.

6. Analyzer according to claim 3, characterized in that the external memory contains information, updated by the electronic processing system, on tests effected and requested and on tests effected but not requested.

7. Analyzer according to claim 1, characterized in that the external memory contains information characteristic of a batch of disposable rotors.

8. Analyzer according to claim 1, characterized in that the external memory is a microcircuit card.

9. Analyzer according to claim 1, characterized in that the external memory is a Compact Flash type card.

10. Analyzer according to claim 1, characterized in that the external memory is a USB key.

11. Analyzer according to claim 1, characterized in that the digital diluter includes a piston actuated by a motor, this piston and this motor being mounted on the chassis, and a manipulation handle provided with a sampling and injection nozzle, which enables dilution of the sample to be analyzed to a ratio defined as a function of the species of the sample to be analyzed.

12. Analyzer according to claim 1, characterized in that the centrifuging module includes an eccentric stepper motor, pinions fixed to the shaft of this motor and to a drive shaft carrying the rotor in use and a belt cooperating with these pinions.

13. Analyzer according to claim 1, characterized in that the reference light sensor (16) is mounted, inside the optical module, on a beam splitter (17).

14. Analyzer according to claim 1, characterized in that the optical module includes a monochromator, optionally a filter wheel (18).

15. Analyzer according to claim 1, characterized in that the electronic control system includes input means for entering the species to which the blood sample belongs, and activates the dilution module as a function of that input.

16. Analyzer according to claim 1, characterized in that the electronic control system includes input means for entering individual tests to be effected in the rotor in use.

17. Analyzer according to claim 1, characterized in that it includes a module (19) for regulating the temperature of the measuring chamber (20) to a precise and stable temperature by means of pulsed air and a Peltier system.

18. Analyzer according to claim 2, characterized in that the external memory further contains information, updated by the electronic processing system, on the use of the rotor in use.

19. Analyzer according to claim 18, characterized in that the external memory contains information characteristic of a batch of disposable rotors.

20. Analyzer according to claim 19, characterized in that the digital diluter includes a piston actuated by a motor, this piston and this motor being mounted on the chassis, and a manipulation handle provided with a sampling and injection nozzle, which enables dilution of the sample to be analyzed to a ratio defined as a function of the species of the sample to be analyzed.
